(19) United States
(12) Patent Application Publication
(10) Pub. No.: US 2011/0274304 A1
(43) Pub. Date: Nov. 10, 2011

(54) Speaker size adapting method

(76) Inventors: Robert Scott Wafer, Ormond Beach, FL (US); David Dean Schaefer, De Leon Springs, FL (US); Colin Becker Ehrhardt, South Dayton, FL (US)

(21) Appl. No.: 12/800,092

(22) Filed: May 7, 2010

(51) Int. Cl. H04R 1/02

(52) U.S. Cl. 381/332

(57) ABSTRACT

A method for adapting a small stereo speaker for mounting in a hole designed for a larger speaker (the hole being in a mounting wall). A pair of adapters are provided. These are plates which include an inner perimeter and an outer perimeter. When the two plates are placed together (like book ends) the inner perimeters of the two plates define an opening appropriately sized for the small speaker. The outer perimeters of the two plates include mounting holes and/or slots which are sized and positioned to align with the mounting holes typically used for the larger speaker.

### CROSS-REFERENCES TO RELATED APPLICATIONS

Not applicable.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of stereo speakers. More specifically the invention comprises a method for fitting a relatively small size speaker into an opening intended for a regularly large size speaker.

2. Description of the Related Art

Car stereo speakers are made in several loosely standardized sizes. One of these sizes is a “4×10.” A “4×10” is an elliptical speaker where the long axis is approximately 10 inches long and the short axis is approximately 4 inches long. FIG. 1 depicts a prior art installation scenario for a 4×10 car stereo speaker. Mounting wall 12 is depicted as a flat plate. In reality it may be a complex shape that is only flat in the vicinity of 4×10 speaker opening 14.

The main structural element of 4×10 speaker assembly 18 is frame 20. Diaphragm 22 is connected to frame 20 by surround 24 (a pliable joint). The mounting hole locations for 4×10 speakers are not universal, but they may be generally grouped into three categories. In the example shown, four quadrangle mounting holes 16 are provided in mounting wall 12 to attach the speaker. Frame 20 is provided with four quadrangle through holes 30, which are positioned to align with quadrangle mounting holes 16 when the speaker assembly is placed in 4×10 speaker opening 14. One or more of the holes may be elongated to provide some margin for adjustment.

The four quadrangle mounting holes are typically provided with a captured threaded insert. Fasteners 26 are passed through the quadrangle through holes 30 and threaded into the four quadrangle mounting holes 16 to draw frame 20 tightly against mounting wall 12. The fasteners employed typically include vibration resisting features such as lock washers or nylon inserts (since the connections will be subject to significant vibration produced by the speaker). FIG. 2 shows the speaker assembly after it has been mounted. Four fasteners 26 have been tightened to draw frame 20 tightly against mounting wall 12.

Prior art speaker frames are typically provided with several sets of mounting holes intended to encompass the most common hole configurations found in the mounting wall. Some of these may be located on extended tabs or flanges. FIGS. 3 and 4 illustrate the location and use of these alternate mounting features. FIG. 3 depicts a mounting wall 12 having its holes located on axis 32 (the long axis of an elliptical opening). These holes are designated as axis mounting holes 34 in the view.

The speaker frame is provided with a paid of axial tabs 36. Each of these include an axial through hole 38 positioned to align with an axis mounting hole 34. One or both of the through holes may be elongated to allow for adjustment. As for the example in FIGS. 1 and 2, fasteners are passed through the axial through holes 38 in the example of FIG. 3 and tightened to draw the speaker against the mounting wall.

FIG. 4 shows still another alternate configuration known in the prior art. This particular mounting wall includes a pair of upper mounting holes 42 positioned above the level of axis 32. Frame 20 is provided with a pair of upper tabs 28. Each upper tab includes an upper through hole 44 positioned to align with an upper mounting hole 42 on mounting wall 12. Fasteners 26 are used to secure the speaker assembly as for the prior example.

The examples depicted in FIGS. 1 through 4 were based on a “4×10” speaker. It is also common to use “4×6” speakers. These are also elliptical, but the long axis measures only six inches. FIG. 5 shows a representative 4×6 speaker assembly 46. 4×6 speaker assembly 46 includes frame 20 and diaphragm 22. Each corner frequently provides a through hole array rather than a single through hole. Each through hole array—designated as 52 in the view—includes a plurality of holes and/or slots designed so that at least one of them will align with a mounting hole 50 proximate 4×6 speaker opening 48. Fasteners 26 are used to attach the speaker assembly as for the prior examples.

The reader will observe that 4×6 speaker opening 48 is considerably smaller than the opening used for a 4×10 speaker (such as shown in FIG. 1). This is the normal situation in the prior art. Speaker openings are sized to receive a particular speaker. A small speaker requires a small opening and a large speaker requires a large opening.

Those skilled in the art will also know that it is sometimes desirable to place a small speaker where a large speaker was previously mounted. One example would be a situation where the installer wishes to mount a 4×6 speaker in a hole designed for a 4×10 speaker. In studying the geometry of 4×6 speaker assembly 46 in FIG. 5, the reader will rapidly appreciate that the mounting holes provided will not align with any of the mounting holes customarily used in a 4×10 speaker opening.

One could of course alter the frame of the 4×6 speaker to make it larger. This would destroy the installer's ability to install that speaker in an opening for a 4×6 speaker. It would be preferable to provide a method for adapting the existing geometry of the smaller speaker frame to fit the larger opening. The present invention proposes a method for accomplishing this objective.

### BRIEF SUMMARY OF THE INVENTION

The present invention comprises a method for adapting a small stereo speaker for mounting in a hole designed for a larger speaker (the hole being in a mounting wall). A pair of adapters is provided. These are plates which include an inner perimeter and an outer perimeter. When the two plates are placed together (like book ends) the inner perimeters of the two plates define an opening appropriately sized for the small speaker.

The outer perimeters of the two plates include mounting holes and/or slots which are sized and positioned to align with the mounting holes typically used for the larger speaker. Thus, the small speaker is attached to the two adapters and the two adapters are attached to the mounting wall. The two adapters can be attached to the small speaker first, or to the mounting wall first.

### BRIEF DESCRIPTION OF THE SEVERAL VIEWS OF THE DRAWINGS

FIG. 1 is an exploded perspective view, showing one type of installation for a prior art large stereo speaker.

FIG. 2 is a perspective view, showing the components of FIG. 1 in an assembled state.

FIG. 3 is an exploded perspective view, showing a second type of installation for a prior art large stereo speaker.

FIG. 4 is an exploded perspective view, showing a third type of installation for a prior art large stereo speaker.

FIG. 5 is an exploded perspective view, showing an installation for a prior art small stereo speaker.

FIG. 6 is a plan view, showing a left adapter made according to the present invention.

FIG. 7 is a plan view, showing a left adapter and a right adapter made according to the present invention.

FIG. 8 is a detailed perspective view, showing the reinforcing features of the adapters.

FIG. 9 is an exploded perspective view, showing the installation of the adapters.

FIG. 10 is a perspective view, showing the components of FIG. 9 in an assembled state.

FIG. 11 is an exploded perspective view, showing the completion of the assembly process.

REFERENCE NUMERALS IN THE DRAWINGS

| | | | |
|---|---|---|---|
| 12 | mounting wall | 14 | 4x10 speaker opening |
| 16 | quadrangle mounting hole | 18 | 4x10 speaker assembly |
| 20 | frame | 22 | diaphragm |
| 24 | surround | 26 | fastener |
| 28 | upper tab | 30 | quadrangle through hole |
| 32 | axis | 34 | axis mounting hole |
| 36 | axial tab | 38 | axial through hole |
| 42 | upper mounting hole | 44 | upper through hole |
| 46 | 4x6 speaker assembly | 48 | 4x6 speaker opening |
| 50 | mounting hole | 52 | mounting hole array |
| 54 | left adapter | 56 | 4x6 speaker relief |
| 58 | outer perimeter | 60 | inner perimeter |
| 62 | right adapter | 64 | outward facing lip |
| 66 | inward facing lip | 68 | adapter assembly |
| 70 | main plate | 72 | main plate |

### DETAILED DESCRIPTION OF THE INVENTION

The present invention is a method for mounting a small speaker in an opening originally intended for a large speaker. There are numerous examples of this situation involving a virtually endless variety of speaker sizes. The example selected for the illustrations is a scenario where an installer desires to mount a 4×6 speaker in an opening that is sized to receive a 4×10 speaker.

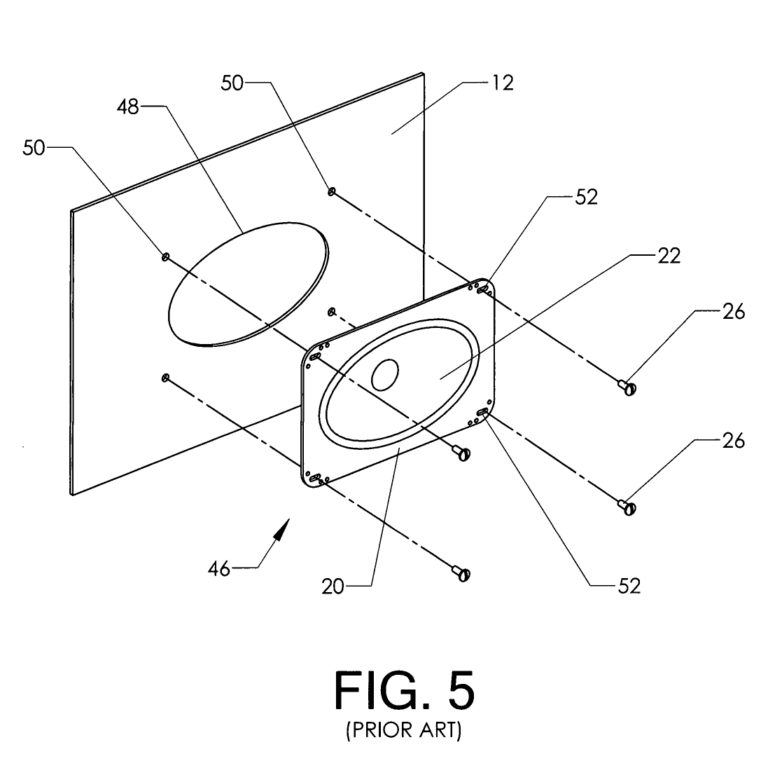

FIG. 5 shows 4×6 speaker assembly 46. 4×6 speaker opening 48 is sized to receive the diaphragm 22 of the speaker, along with a portion of frame 20 which extends inward beyond the diaphragm (Those skilled in the art will know that the frame must mount an electromagnet which is attached to the back of the diaphragm). The 4×6 speaker opening is relatively small, since it is proportioned to the 4×6 speaker.

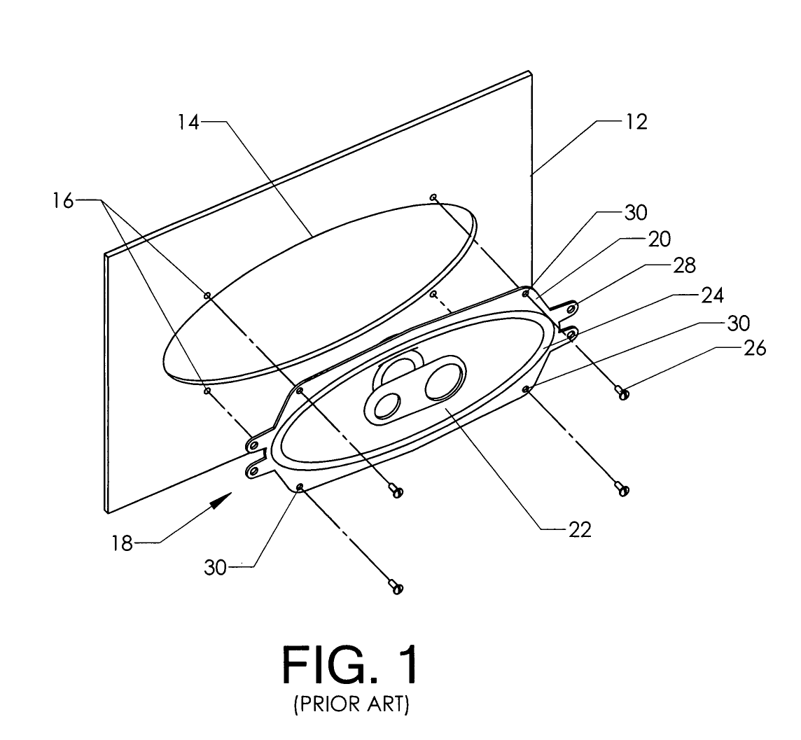

Turning back to FIG. 1, the reader will observe that 4×10 speaker opening 14 is much longer than the opening for the 4×6 speaker. This results from the fact that it is proportioned to the dimensions of 4×10 speaker assembly 18. The mounting holes located in mounting wall 12 are likewise proportioned for a particular type of speaker.

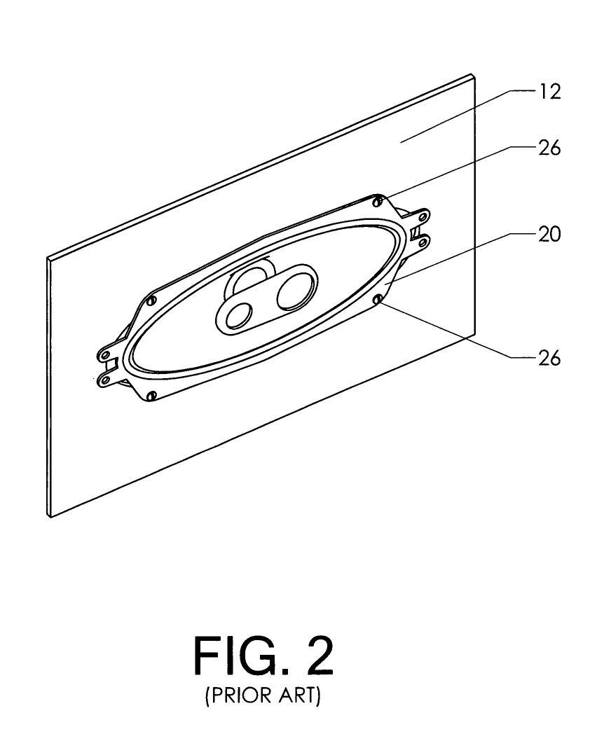

By comparing FIG. 1 to FIG. 5, the reader will readily appreciate that the speaker opening and mounting holes configured to receive a 4×10 speaker will not work for a 4×6 speaker. The present invention solves this problem by providing a method for mounting the 4×6 speaker (“small” speaker) in a speaker opening intended for a 4×10 speaker (“large” speaker).

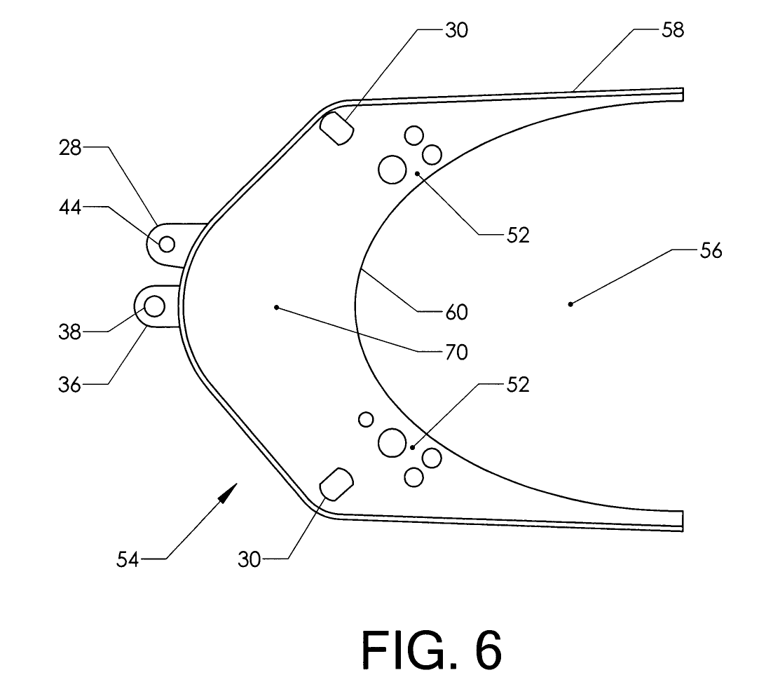

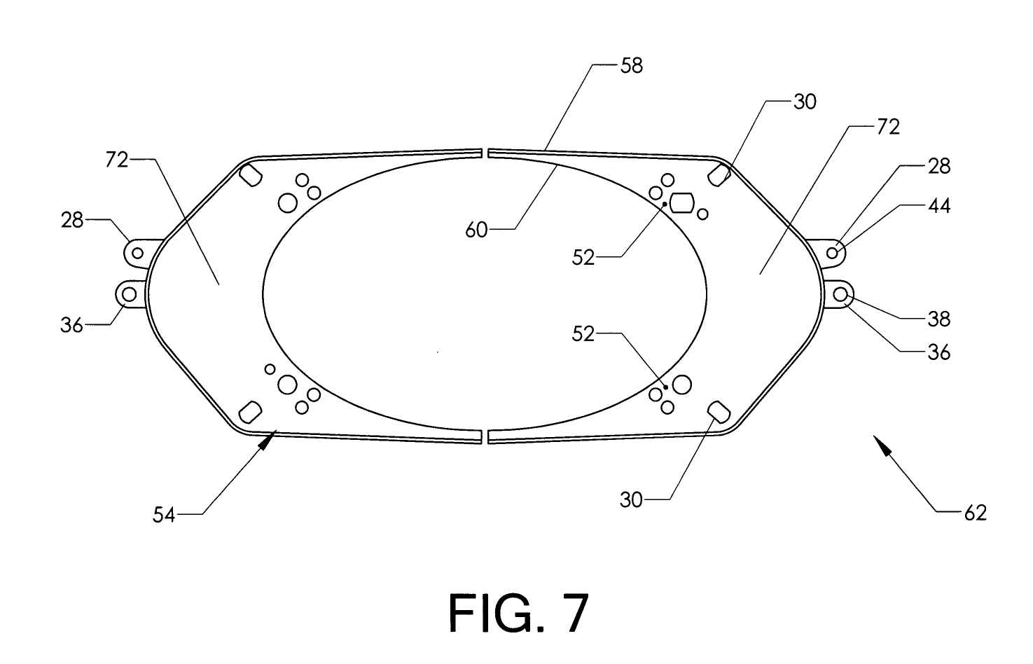

The inventive method includes an adapter which is attached to the small speaker. The adapter is preferably made as two pieces. FIG. 6 shows left adapter 54. FIG. 7 shows left adapter 54 paired with a right adapter 62 (the two adapters preferably being symmetrical).

Returning to FIG. 6, the left adapter is formed by main plate 70, which has inner perimeter 60 and outer perimeter 58. The inner perimeter is configured to approximate one half of the outline found in 4×6 speaker opening 48 (as shown in FIG. 5). Outer perimeter 58 is configured to overlie the perimeter of 4×10 speaker opening 14 (as shown in FIG. 1).

FIG. 7 shows the two symmetric parts in alignment. The two inner perimeters 60 form an opening sized to approximate 4×6 speaker opening 48. The two outer perimeters 58 form an overall perimeter which is preferably slightly larger than 4×10 speaker opening 14. This is desirable so that the two main plates can actually bear against the mounting wall in the final assembly.

FIG. 6 shows numerous mounting features in left adapter 54 (the corresponding mirrored features are found in the right adapter as well). A first set of features is intended to be used to attach the adapter to a 4×6 speaker. A second set of features is intended to be used to attach the adapter to a 4×10 speaker opening. The features intended to attach the adapter to the 4×6 speaker are sets of mounting hole arrays 52 located along inner perimeter 52. These are positioned to align with the through hole arrays 52 shown on the 4×6 speaker assembly in FIG. 5. The 4×6 speaker assembly has four corners. Only two of the corners are accounted for on left adapter 54—with the remaining two corners being located on the right adapter.

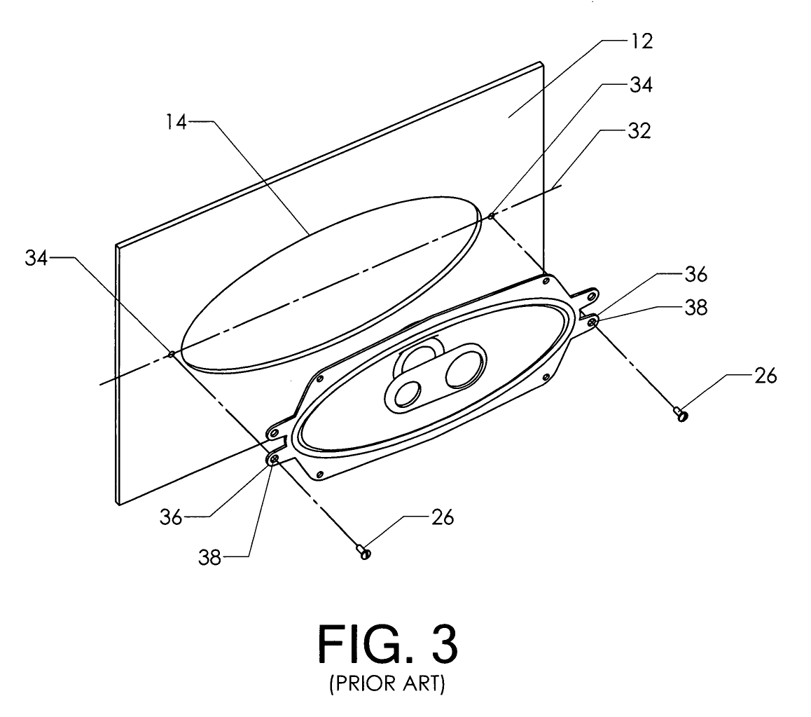

The mounting features designed to be used to affix the left adapter to the 4×10 speaker opening will now be explained. A pair of quadrangle through holes 30 are provided along outer perimeter 58. These are configured to align with quadrangle mounting holes 16 shown in FIG. 1. Of course—as explained previously—there are several different mounting configurations in use for 4×10 speakers. The adapters preferably account for all of these. Thus, left adapter 54 includes an axial tab 36 with an axial through hole 38. These features are positioned to align with axis mounting holes 34 shown in FIG. 3.

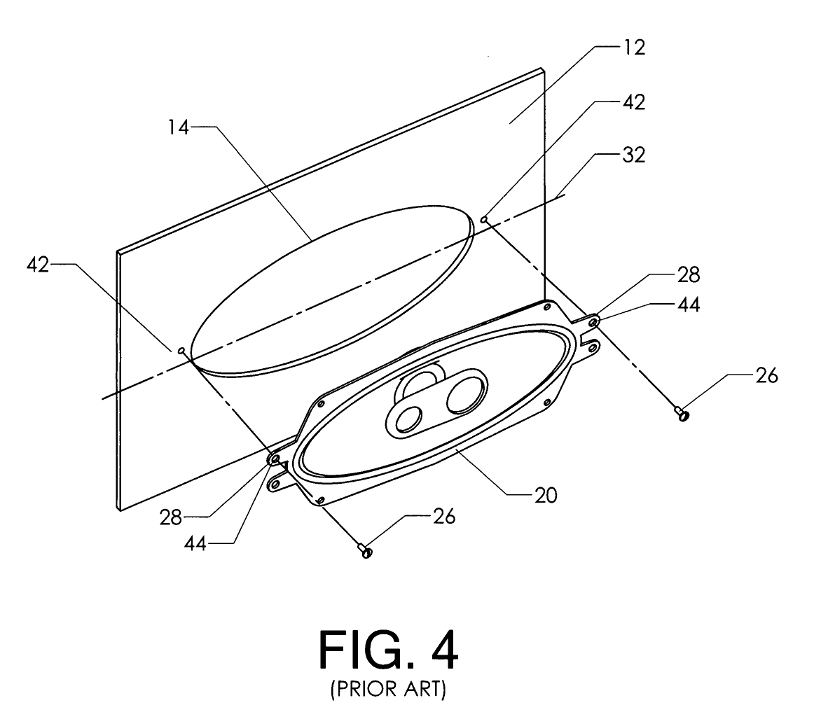

FIG. 6 also shows the presence of upper tab 28 with associated upper through hole 44. These features are positioned to align with upper mounting holes 42 in FIG. 4. The tabs shown can protrude outward beyond the outer perimeter of the adapter, or the outer perimeter can simply be extended to encompass the region needed for these holes. FIG. 7 shows how the features just described are mirrored in right adapter 62.

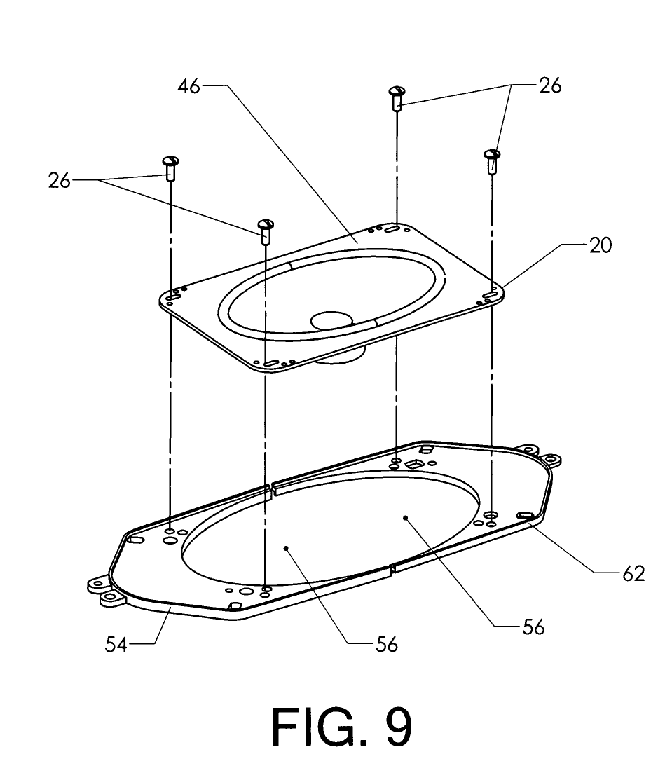

The use of the illustrated hardware in the present inventive method will now be explained. The order of operations performed is not significant to the invention, and the order presented in the following description should thus be viewed as exemplary and not limiting. IN FIG. 9, 4×6 speaker assembly 46 is being mated to left adapter 54 and right adapter 62. Four fasteners 26 are passed through frame 20 and into the corresponding mounting features on the left and right adapters. Any suitable fastening technique can be used. One example is the use of captive nuts on the adapters to receive threaded screws. A second example is simply molding female threads into the adapters. A third example is using undersized through holes in the adapters configured to receive self-tapping screws. A fourth example would be using rivets.

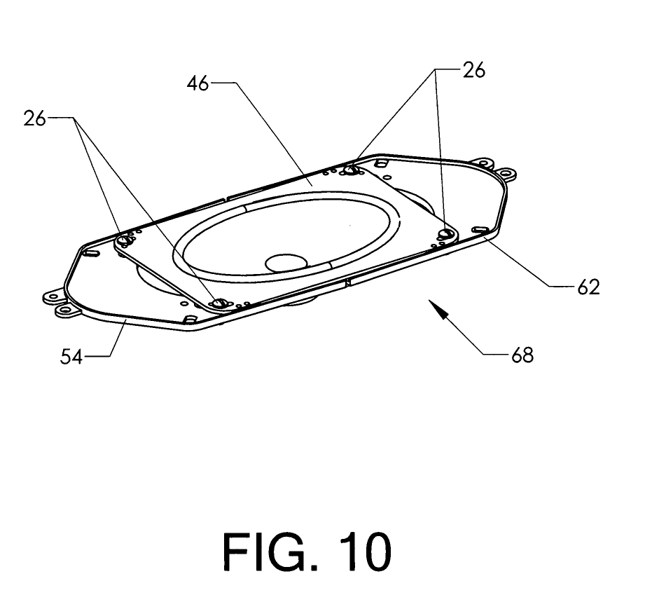

Whatever fastening technique is used, the frame of the 4×6 speaker assembly is at some point attached to the left and right adapters as shown in FIG. 10. The illustration shows the speaker assembly being attached to the outward surface of the left and right adapters. It is also possible to attach the speaker assembly to the inward facing surfaces. The orientation of the speaker assembly and the adapter plates can be selected to suit the particular application.

In FIG. 10, the assembly of the speakers and the two adapters is labeled as adapter assembly 68. The result is a unified whole in which the attached adapters mimic the characteristics of a frame for a 4×10 speaker assembly.

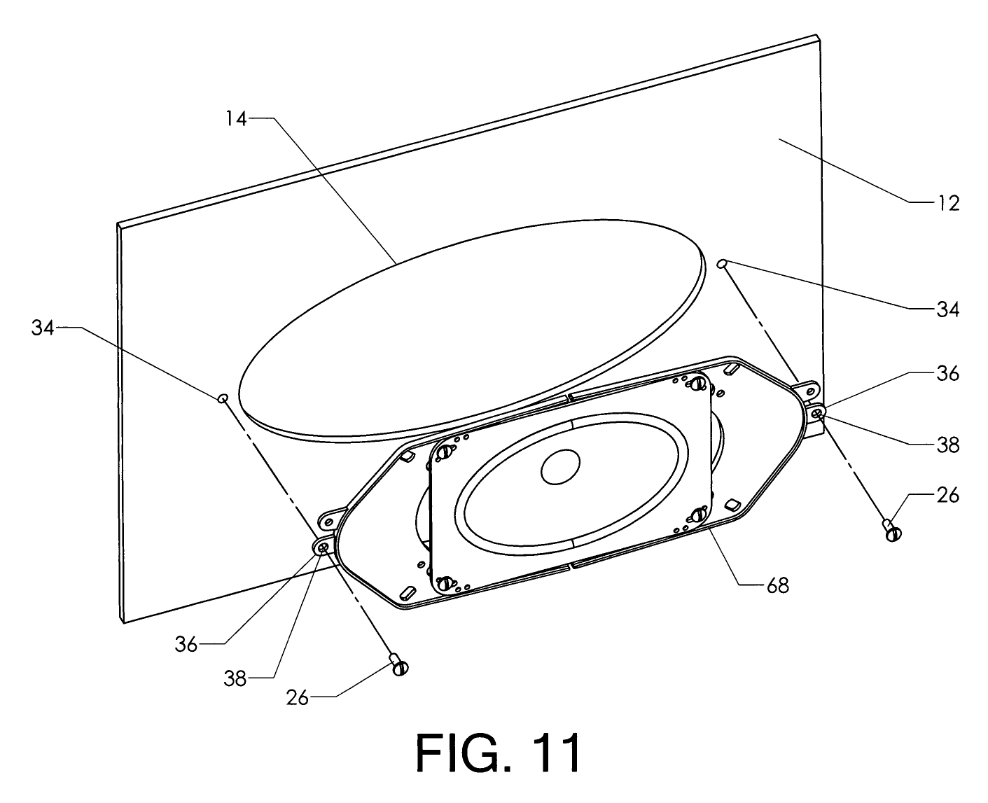

FIG. 11 shows adapter assembly 68 being attached to a mounting wall 12 which includes a 4×10 speaker opening 14. In this particular example, two axis mounting holes 24 are present proximate the 4×10 speaker opening. Accordingly, two fasteners 26 are passed through axial through holes 38 in the two axial tabs 36. The 4×6 speaker is thereby mounted in an opening which was originally intended for a 4×10 speaker.

The assembly sequence will likely be altered for some installations. As an example, it will be desirable in some circumstances to mount the left and right adapters to the mounting wall 12 and then attach the 4×6 speaker to the adapters. A spacing template may be employed in this case to make sure that the two adapters are properly positioned to receive the 4×6 speaker. It is even possible to attach one adapter to the speaker and one to the mounting wall before proceeding with the final assembly.

Whatever order is used, it is desirable for the resulting assembly to be relatively strong and preferably rigid. A car stereo speaker vibrates significantly. Thus, the hardware used to mount the speaker must be able to receive this vibration without working loose. It is also preferable to provide a relatively rigid mounting system so that the sound produced by the speaker is not distorted by unwanted motion of the frame.

Returning now to FIG. 6, some additional features of the adapters will be explained. The main plate 70 is essentially a flat plate. This geometry—standing alone—is not very stiff. It is preferable to provide stiffening features. These can assume the form of upstanding ribs in the flat surface. Another form of reinforcing feature is to add reinforcing “lips” around the inner and outer perimeters.

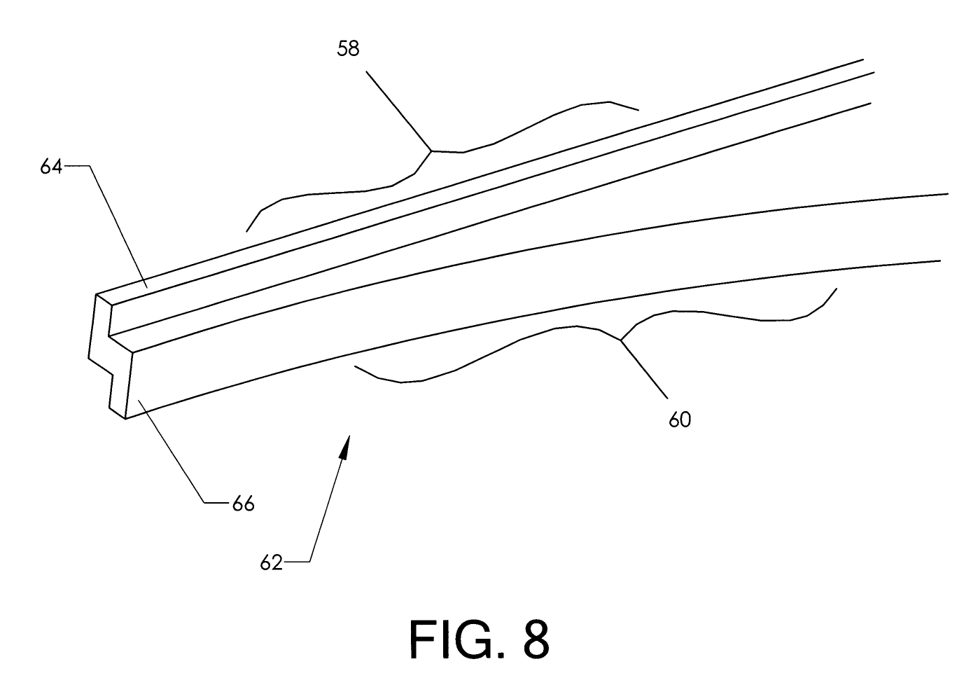

FIG. 8 shows these reinforcing lips in detail. Outward facing lip 64 is located along outer perimeter 58. It faces outward since—as explained previously, the outer perimeter is configured to overlie the speaker opening. Inward facing lip 66 extends inward so it will not interfere with the frame of the 4×6 speaker. The two reinforcing lips substantially stiffen the adapter.

Material selection also plays a role. The mirrored adapters are preferably injection molded to reduce cost. Fiber reinforcing may optionally be used to stiffen the final parts. Of course, the adapters could also be made as metal stampings or castings. Numerous other known techniques could be used to fabricate the required geometry.

Those skilled in the art will realize that the inventive method lends itself to other mounting possibilities as well. The illustrations have focused on using the pair of adapters to mount a variety of single speakers. It is also possible to use the adapters to mount a pair of small speakers (such as 3½ inch speakers) in a 4×10 location.

The preceding description contains significant detail regarding the novel aspects of the present invention. It should not be construed, however, as limiting the scope of the invention but rather as providing illustrations of the preferred embodiments of the invention. As one example, the unitary structures depicted for each of the adapters could be made as multi-piece assemblies that are unified during assembly. Thus, the scope of the invention should be fixed by the following claims, rather than by the examples given.

Having described my invention, I claim:

1. A method of mounting a small speaker in an opening intended for a large speaker comprising:
a. providing a mounting wall, including
i. an opening configured to receive said large speaker, and
ii. a plurality of mounting holes proximate said opening, said plurality of mounting holes being configured to align with through holes provided on said large speaker;
b. providing a small speaker,
i. said small speaker being substantially smaller than said opening,
ii. said small speaker having a left side and a right side,
ii. said small speaker including a frame having four corners, with two of said corners being proximate said left side of said frame and two of said corners being proximate said right side of said frame, and
iii. a through hole proximate each of said four corners;
c. providing a left adapter, said left adapter including,
i. a main plate having an inner perimeter and an outer perimeter,
ii. said inner perimeter being configured to encompass said left side of said small speaker,
iii. a first mounting hole array proximate said inner perimeter and being positioned to engage one of said through holes on said small speaker,
iv. a second mounting hole array proximate said inner perimeter and being positioned to engage a second of said through holes on said small speaker, and
v. at least one through hole proximate said outer perimeter configured to align with one of said plurality of mounting holes in said mounting wall proximate said opening;
d. providing a right adapter, said right adapter including,
i. a main plate having an inner perimeter and an outer perimeter,
ii. said inner perimeter being configured to encompass said right side of said small speaker,
iii. a first mounting hole array proximate said inner perimeter and being positioned to engage a third of said through holes on said small speaker,
iv. a second mounting hole array proximate said inner perimeter and being positioned to engage a fourth of said through holes on said small speaker, and
v. at least one through hole proximate said outer perimeter configured to align with a second of said plurality of mounting holes in said mounting wall proximate said opening;
e. attaching said left and right adapters to said small speaker; and
f. attaching said left and right adapters to said mounting wall.

2. A method of mounting a small speaker in an opening intended for a large speaker as recited in claim 1, further comprising:
a. an inward facing lip connected to said main plate of said left adapter along said inner perimeter; and
b. an inward facing lip connected to said main plate of said right adapter along said inner perimeter.

3. A method of mounting a small speaker in an opening intended for a large speaker as recited in claim 1, further comprising:
a. an outward facing lip connected to said main plate of said left adapter along said outer perimeter; and
b. an outward facing lip connected to said main plate of said right adapter along said outer perimeter.

4. A method of mounting a small speaker in an opening intended for a large speaker as recited in claim 2, further comprising:
a. an outward facing lip connected to said main plate of said left adapter along said outer perimeter; and
b. an outward facing lip connected to said main plate of said right adapter along said outer perimeter.

5. A method of mounting a small speaker in an opening intended for a large speaker as recited in claim 1, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

6. A method of mounting a small speaker in an opening intended for a large speaker as recited in claim 5, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.

7. A method of mounting a small speaker in an opening intended for a large speaker as recited in claim 2, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

8. A method of mounting a small speaker in an opening intended for a large speaker as recited in claim 7, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.

9. A method of mounting a small speaker in an opening intended for a large speaker as recited in claim 3, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

10. A method of mounting a small speaker in an opening intended for a large speaker as recited in claim 9, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.

11. A method of mounting a small speaker in an opening intended for a large speaker comprising:
a. providing a mounting wall, including
i. an opening configured to receive said large speaker, and
ii. a plurality of mounting holes proximate said opening, said plurality of mounting holes being configured to align with through holes provided on said large speaker;
b. providing a small speaker,
i. said small speaker being substantially smaller than said opening,
ii. said small speaker having a left side and a right side,
ii. said small speaker including a frame having four corners, with two of said corners being proximate said left side of said frame and two of said corners being proximate said right side of said frame, and
iii. a through hole proximate each of said four corners;
c. providing a left adapter, configured to attach to said left side of said small speaker using said through holes;
d. providing a right adapter, configured to attach to said right side of said small speaker using said through holes;
e. said left adapter including an inner perimeter and said right adapter including an inner perimeter, said inner perimeters of said left and right adapters combining to form an opening configured to receive said small speaker;
f. said left adapter including an outer perimeter and said right adapter including an outer perimeter, said outer perimeters of said left and right adapters combining to overlie said opening in said mounting wall;
g. attaching said left and right adapters to said small speaker; and
h. attaching said left and right adapters to said mounting wall.

12. A method of mounting a small speaker in an opening intended for a large speaker as recited in claim 11, further comprising:
a. an inward facing lip connected to said left adapter along said inner perimeter; and
b. an inward facing lip connected to said right adapter along said inner perimeter.

13. A method of mounting a small speaker in an opening intended for a large speaker as recited in claim 11, further comprising:
a. an outward facing lip connected to said left adapter along said outer perimeter; and
b. an outward facing lip connected to said right adapter along said outer perimeter.

14. A method of mounting a small speaker in an opening intended for a large speaker as recited in claim 12, further comprising:
a. an outward facing lip connected to said left adapter along said outer perimeter; and
b. an outward facing lip connected to said right adapter along said outer perimeter.

15. A method of mounting a small speaker in an opening intended for a large speaker as recited in claim 11, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

16. A method of mounting a small speaker in an opening intended for a large speaker as recited in claim 15, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.

17. A method of mounting a small speaker in an opening intended for a large speaker as recited in claim 12, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

18. A method of mounting a small speaker in an opening intended for a large speaker as recited in claim 17, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.

19. A method of mounting a small speaker in an opening intended for a large speaker as recited in claim 13, further comprising:
a. providing an axial tab proximate said outer perimeter of said left adapter;
b. locating said at least one through hole on said left adapter on said axial tab;
c. providing an axial tab proximate said outer perimeter of said right adapter; and
d. locating said at least one through hole on said right adapter on said axial tab.

20. A method of mounting a small speaker in an opening intended for a large speaker as recited in claim 19, further comprising:
a. providing an upper tab proximate said outer perimeter of said left adapter;
b. providing a second through hole on said left adapter on said upper tab;
c. providing an upper tab proximate said outer perimeter of said right adapter; and
d. providing a second through hole on said right adapter on said upper tab.
